(19) United States
(12) Patent Application Publication
(10) Pub. No.: US 2011/0168277 A1
(43) Pub. Date: Jul. 14, 2011

(54) PRESSURE RELIEF VALVE WITH REVERSE THREADED INLET

(75) Inventor: Lawrence M. Dulac, Belmont, NH (US)

(73) Assignee: Larco LLC, Belmont, NH (US)

(21) Appl. No.: 13/069,955

(22) Filed: Mar. 23, 2011

Related U.S. Application Data
(63) Continuation-in-part of application No. 12/328,086, filed on Dec. 4, 2008.

(51) Int. Cl. F16K 17/38; F16K 51/00; F16K 17/04

(52) U.S. Cl. 137/468; 251/148; 137/535

(57) ABSTRACT

A safety discharge system comprises a pressure relief valve having an inlet, designed to mate with an outlet of a heating appliance, and a relief outlet, wherein at least the inlet of the pressure relief valve and the outlet of the heating appliance include a threaded region, and wherein the threaded region is threaded with a reverse or left handed thread.

### CROSS REFERENCE TO RELATED APPLICATION

This application is a continuation-in-part of U.S. patent application Ser. No. 12/328,086 filed on Dec. 4, 2008 entitled “Relief Valve With Fluid Outlet” and published as publication No. 20100139789-A1 which is incorporated fully herein by reference.

### TECHNICAL FIELD

The present invention relates to pressure relief valves and more particularly, to a pressure relief valve that is provided with a reverse threaded inlet designed to mate with a reverse threaded outlet on a heating appliance or other device.

### BACKGROUND INFORMATION

Residential and commercial water heaters and boilers typically include a pressurized tank or vessel where heated water is stored until it is required for use. The temperature and pressure of the water being stored will typically vary within a predetermine limit as the water heater operates normally. When there is a malfunction, the temperature and/or pressure of the water stored within even a common residential hot water heater, for example, will rise, sometimes significantly, and can cause the device to explode with severe force and violent consequences in that this explosion can inflict severe injury and damage, even death. For example, if the tank fails due to excessive pressure in the water supply, boiling of the water, or age, extremely hot water may spread with explosive force thrusting the tank over a considerable distance.

In order to prevent these catastrophic results, residential and commercial water heaters and boilers include a pressure relief valve that releases water/steam when the temperature and/or pressure of the water in the tank exceeds a predetermined value. The discharge side of the relief valve is typically connected to a discharge pipe, which releases the pressurized hot water into a reservoir or along the floor where there is less danger of injury to individuals.

While there are a variety of known relief valves used with water heaters and boilers, they all suffer from a general design flaw in that they are provided with a threaded connection to allow a user or plumber to plumb the discharge to the desired location. However, this threaded connection also allows a user to block, plug or reconfigure the use of the relief valve outlet.

Many systems do not utilize reservoirs or drains and users will often permanently plug the outlet of the relief valve to prevent water from dripping onto the floor. The act of permanently plugging the outlet of a relief valve is commonplace and renders the relief valve completely useless and thus has resulted in many injuries and deaths due to the inability of the plugged relief valve to perform as it was intended. A user can easily attach a plug, cap or cover over the relief valve outlet, which blocks the escape of water from exiting in an emergency. Blocking the relief valve outlet completely eliminates the effectiveness of the relief valve and can lead to the serious problems already discussed. One method of preventing a user from blocking the pressure relief valve outlet is disclosed in U.S. Pat. No. 6,698,714 by the present inventor herein and incorporated herein by reference.

A further problem exists, however, in that a user can also remove the pressure relief valve completely and then attach a different device or plug directly to the water heater, boiler or other heating appliance. In some instances, users have attached pipes in place of the relief valve to circulate water to new heating zones in the house or for other purposes, such as direct drainage. Using the pressure relief valve portal for any other purpose than for what it was intended (i.e. connection with a pressure relief valve) can lead to serious, dangerous and even fatal consequences.

Further, while there are a variety of known relief valves used with water heaters and boilers, the relief valves may develop slow leaks or the valve's internal workings or “seat” may become clogged with an accumulation or build-up of water born minerals or the like. The build-up restricts the ability of the valve to function properly and efficiently without any hindrance. Therefore, there is a critical need for a valve that can constantly clean and flush the valve seat to remove the particles that buildup near the valve seat. This build up is becoming even more prevalent now that hot water tanks are being manufactured with more and thicker insulation. Thus, the valve “stems” on the pressure relief valves that are inserted into these more highly insulated hot water tanks must be made longer resulting in more mineral deposits due to colder temperature of the valve seat.

Accordingly, what is needed is a pressure relief valve outlet on a heating appliance that cannot be tampered with and cannot be blocked, plugged or otherwise rendered ineffective for its intended purpose and that can only mate with a pressure relief valve. In addition, it would be desirable to have a fluid discharge system that would allow reduction of the possibility of blockage or clogging of a valve while still allowing the valve to properly function if the tank or boiler becomes unsafe.

### SUMMARY

The present invention features a pressure relief valve system having a reverse thread interface to a heating appliance that also has a reverse thread such that only the reverse threaded pressure relief valve can mate with the reverse threaded region on the heating appliance.

The invention includes a safety discharge system for a heating appliance having a threaded fluid outlet. The safety discharge system comprises a relief valve having a threaded inlet, for threadably mating with said threaded fluid outlet of said heating appliance, wherein at least the threads of the threaded relief valve inlet and the threads of the threaded heating appliance fluid outlet are threaded with a reverse, left hand thread.

In another embodiment, the invention includes a relief valve comprising a housing, the housing comprises a threaded supply line inlet, for threadably mating with a threaded fluid outlet of a heating appliance, wherein at least the threads of the threaded supply line inlet and the threads of the threaded heating appliance fluid outlet are threaded with a reverse, left hand thread, the threaded supply line inlet for allowing fluid to enter the housing. A relief outlet, in fluid communication with the housing has an inlet region and an outlet region. A valve mechanism is disposed in the housing between the supply line inlet and the inlet region of the relief outlet, and includes a valve seat in fluid communication with the housing, and configured for operation between a first, closed position closing the inlet region of the relief outlet inlet region thereby preventing fluid from exiting the relief outlet, and a second, open position opening the inlet region of the relief outlet inlet region, thereby allowing fluid to exit from the housing through the relief outlet. A fluid supply outlet is provided in fluid communication with the housing, and configured for allowing fluid to exit the housing when the valve seat is in the closed position and for causing a fluid flow exiting the housing to flow proximate and against the valve seat, for flushing debris from the valve seat.

The outlet region of the relief outlet may open to the atmosphere while the valve mechanism may be a temperature relief valve mechanism, and wherein the temperature relief valve mechanism is operative to move from the first position to the second position upon detecting at least one of a predetermined temperature or pressure in the fluid in the housing.

The valve mechanism may be a temperature relief valve mechanism, wherein the temperature relief valve mechanism is operative to move from the first position to the second position upon detecting at least one of a predetermined temperature or pressure in a fluid holding tank into which the relief valve is inserted.

In another embodiment, the supply line inlet is connected to a water heater tank for supplying hot water from a tank to the housing. The supply line inlet may further comprise an externally threaded region for engaging with an internally threaded region of the heating appliance.

The supply line outlet may further comprise an internally threaded region, for engaging with an externally threaded region of an adaptor. The pressure relief valve may further comprise a thermal sensing element disposed along the supply line inlet and extending beyond the supply line inlet into the heating appliance. The pressure relief outlet section may further comprise an internally threaded region for engaging with an externally threaded region of an adaptor.

The pressure relief valve may further comprise a bushing, coupled to the relief outlet region and configured to disengage from the relief valve outlet at a predetermined pressure allowing the relief valve to function as intended.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a plan view of a heating appliance (hot water tank) on which has been installed a pressure relief valve according to the present invention;

FIG. 2 is a perspective view of the pressure relief valve of the present invention; and

FIG. 3 is a perspective view of a second embodiment of the pressure relief valve with reverse threads according to the present invention.

### DETAILED DESCRIPTION OF THE PREFERRED EMBODIMENTS

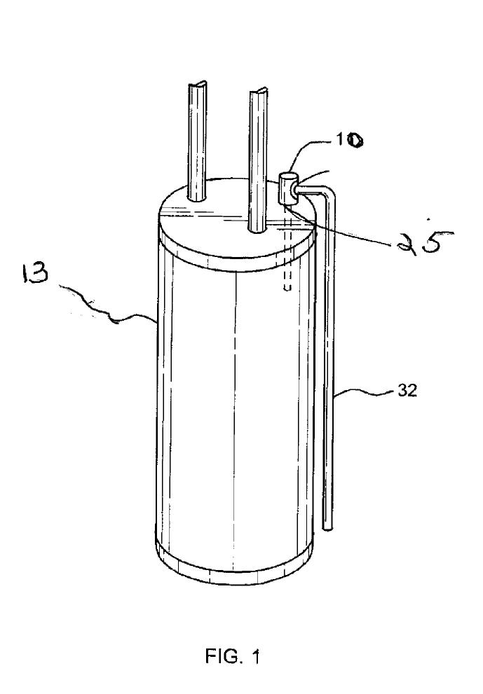

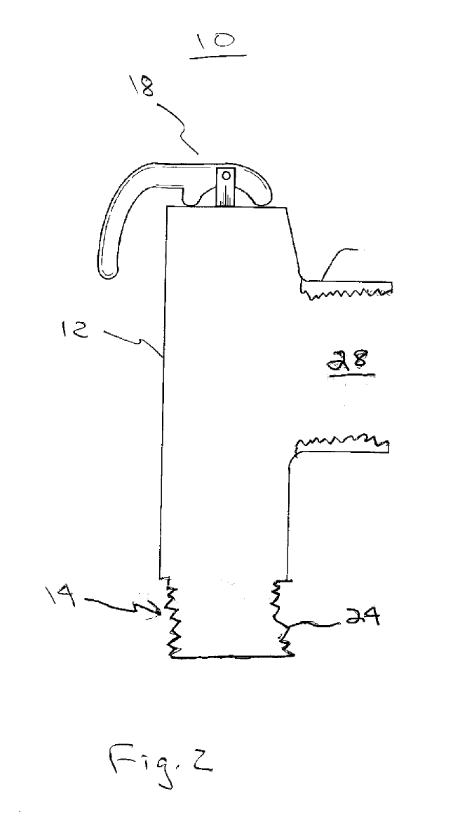

The present invention features, as shown in FIGS. 1 and 2, a pressure relief valve 10 that is designed to attach to a water heater, boiler, or other heating appliance 13. According to the present invention, the relief valve 10 features a relief valve body 12. The relief valve 10 may be any type of relief valve and can be designed for any type of fluid (i.e. liquid or gaseous). The relief valve 10 has a fluid supply inlet 14, and a discharge or relief outlet 28, and a pressure/temperature control mechanism represented generally at 18, as is well known in the art. The fluid supply inlet 14 is designed to be connected to a heating appliance 13 (as shown in FIG. 1).

Although the fluid supply inlet 14 and discharge or relief outlet 28 are shown in specific locations (bottom and side respectively) on the relief valve 10, this is not a limitation of the invention as the inlet may be located on a side region and the outlet on a bottom region of the pressure relief valve 10, all without departing from the scope of the present invention.

The fluid supply inlet 14 introduces fluid into the relief valve 10. The fluid supply inlet 14 typically includes a threaded region, which is typically, although not exclusively, an externally threaded region 24. The externally threaded region 24 is configured for threadably interconnecting with a mating internally threaded region 25 on the heating appliance, for allowing hot water from the appliance to escape through the valve housing or body 12 if and when the pressure/temperature control mechanism releases.

The threaded region 24 of the fluid supply inlet 14 and the mating internally threaded region 25 on the heating appliance 13 feature a reverse thread (left hand thread). The benefit of using a reverse or left handed thread on a heating appliance output 25 and on the fluid supply inlet 14 is that a user cannot simply remove the pressure relief valve 10 and attach a conventionally threaded cap, cover, water line or other device in its place. In this way, only a specified reverse threaded pressure relief valve can be attached to the reversed threads of the heating appliance outlet 25 designed for a pressure relief valve. A user is prevented from attempting to otherwise attach a cap or blocking mechanism to the heating appliance outlet 25. Moreover, the user is also prevented from blocking the outlet 28 of the pressure relief valve by virtue of the device disclosed and claimed in Applicant's U.S. Pat. No. 6,698,714.

Fluid entering the fluid supply inlet 14 continues to flow through the relief valve body 12 and then may exit the relief valve 10 at a fluid supply outlet 28.

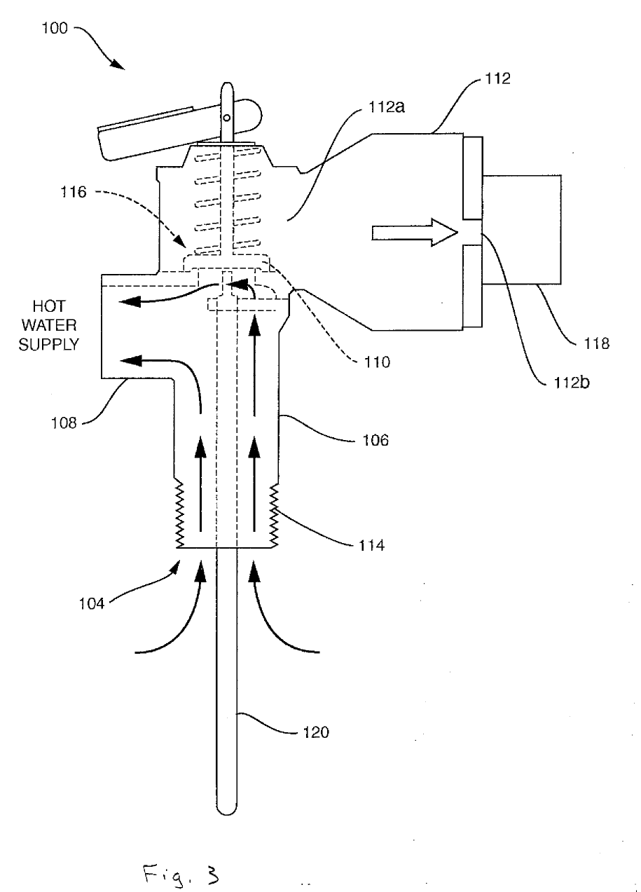

In another embodiment, the relief valve 100, FIG. 3, may also include a flow through outlet 108, such as disclosed in Applicant's published United States Patent Application US-2010-0139789-A1 incorporated herein by reference.

The relief valve 100 in this embodiment includes a housing or body 100 that includes a supply line inlet 104. This supply line inlet 104 introduces fluid into the relief valve. The supply line inlet 104 typically includes an externally threaded region 114 configured for threadably interconnecting with a water heater tank, for supplying hot water from the tank to the valve housing. In the present invention, the threaded region 114 includes a reverse pipe thread designed to mate with a correspondingly sized reverse threaded female outlet on a heating appliance or other pressurized vessel. The supply line inlet 104 may be connected to a fluid source/pressurized vessel using various connection mechanisms such as externally and internally threaded regions and the like however, either would be reverse threaded. Thus using the relief valve 100 of this embodiment, a hot water tank, for example, would only have to be provided with two fittings: one for a cold water inlet and one for the relief valve 100 of the present embodiment of the invention which serves as both a fluid outlet and a pressure relief outlet. This savings of one outlet will eliminate one possible failure point in the hot water tank and save manufacturing time and money.

Fluid entering the inlet 104 continues to flow along a supply line 106 and then exits the valve 100 at a fluid supply outlet 108. The supply line outlet 108 may include a connection mechanism for engaging/connecting with an adaptor such as, by way of example only, an externally or internally threaded region. The supply line 106 and outlet 108 are configured for allowing and in fact causing fluid entering and exiting the valve to flow proximate, around and/or against a valve seat 110 of the valve. By allowing fluid to flow past, around and/or against the seat of the valve, the seat is flushed or cleansed of any deposits or materials that have built-up on or around the seat's and its surfaces. This cleansing or flushing action prevents any buildup of materials within the interior of the valve which might otherwise prevent the valve from properly functioning in an emergency situation.

The housing of the relief valve also has a relief outlet 110 that is in fluid communication with the supply line 106. The relief outlet 110 has an inlet region 112a and outlet region 112b. The outlet region 112b of the relief outlet opens to the atmosphere.

The valve mechanism 116 is disposed in the housing between the supply line inlet 104 and the inlet region 112a of the relief outlet. The relief valve 100 may include a temperature relief valve mechanism 116 where the valve mechanism 116 is operative to move from a first position to a second position upon detecting a certain temperature or pressure of the fluid within the valve housing or within the holding tank into which the relief valve is inserted. The temperature relief mechanism may also include a thermal sensing element 120 that is preferably disposed in the supply line and/or extends beyond the supply line inlet into the tank.

The valve mechanism 116 includes a valve seat 110 configured for operation between a first, closed position and a second, open position. In the closed position, the inlet region 112a is blocked thereby preventing fluid from exiting through the relief outlet 112 allowing fluid to exit the valve 100 by means of outlet 108. In the open position, the inlet region 112a is opened up so that fluid can exit from the housing through the relief outlet 112b to relieve excess pressure. The pressure relief outlet 112b section may be connected to a discharge pipe or the like 118 using various connection mechanisms such as externally and internally threaded regions, soldering and the like. In another embodiment, the valve relief outlet 112b may be connected to or may include a built in device to prevent the valve 100 from being blocked and that can disengage from the relief valve at a predetermined pressure allowing the relief valve to function as intended such as disclosed in U.S. Pat. No. 6,698,714 by the present inventor and incorporated herein fully be reference.

Thus, the pressure relief valve with reverse inlet threads in accordance with the present invention can be used in conjunction with any heating appliance 13 or pressurized vessel that would benefit from the use of a relief valve and that is provided with a reverse threaded region. The use of a reverse thread at one or more attachment locations (fluid supply inlet and heating appliance output) prevents a user from blocking the relief valve portal and/or openings of the heating appliance and relief valve with a cap or cover or other blocking device. The use of a reverse thread also prevents a user from retrofitting the various portals and openings of the heating appliance and relief valve to be used as supply lines for other heating zones or for other purposes. As a result of the use of reverse threads, the heating appliance and relief valve are protected from tampering and manipulation that would render the safety benefits of the relief valve useless.

Modifications and substitutions by one of ordinary skill in the art are considered to be within the scope of the present invention, which is not to be limited except by the following claims.

The invention claimed is:

1. A safety discharge system for a heating appliance having a threaded fluid outlet, said safety discharge system comprising:
a relief valve having a threaded inlet, for threadably mating with the threaded fluid outlet of the heating appliance, wherein at least the threads of the threaded relief valve inlet and the threads of the threaded heating appliance fluid outlet are threaded with a reverse, left hand thread.

2. A relief valve comprising:
a housing, the housing comprising:
a threaded supply line inlet, for threadably mating with a threaded fluid outlet of a heating appliance, wherein at least the threads of the threaded supply line inlet and the threads of the threaded heating appliance fluid outlet are threaded with a reverse, left hand thread, the threaded supply line inlet for allowing fluid to enter the housing;
a relief outlet, in fluid communication with the housing and having an inlet region and an outlet region;
a valve mechanism, disposed in the housing between the supply line inlet and the inlet region of the relief outlet, and including a valve seat in fluid communication with the housing, and configured for operation between a first, closed position closing the inlet region of the relief outlet inlet region thereby preventing fluid from exiting the relief outlet, and a second, open position opening the inlet region of the relief outlet inlet region, thereby allowing fluid to exit from the housing through the relief outlet; and
a fluid supply outlet, in fluid communication with the housing, and configured for allowing fluid to exit the housing when the valve seat is in the closed position and for causing a fluid flow exiting the housing to flow proximate and against the valve seat, for flushing debris from the valve seat.

3. The relief valve of claim 2, wherein the outlet region of the relief outlet opens to the atmosphere.

4. The relief valve of claim 2, wherein the valve mechanism is a temperature relief valve mechanism, and wherein the temperature relief valve mechanism is operative to move from the first position to the second position upon detecting at least one of a predetermined temperature or pressure in the fluid in the housing.

5. The relief valve of claim 2, wherein said valve mechanism is a temperature relief valve mechanism, and wherein said temperature relief valve mechanism is operative to move from said first position to said second position upon detecting at least one of a predetermined temperature or pressure in a fluid holding tank into which said relief valve is inserted.

6. The pressure relief valve of claim 2, wherein the supply line inlet is connected to a water heater tank for supplying hot water from a tank to the housing.

7. The pressure relief valve of claim 2, wherein the supply line inlet further comprises an externally threaded region for engaging with an internally threaded region of said heating appliance.

8. The pressure relief valve of claim 2, wherein the supply line outlet further comprises an internally threaded region for engaging with an externally threaded region of an adaptor.

9. The pressure relief valve of claim 2, further comprising a thermal sensing element disposed along the supply line inlet and extending beyond the supply line inlet into the heating appliance.

10. The pressure relief valve of claim 2, wherein the pressure relief outlet section further comprises an internally threaded region for engaging with an externally threaded region of an adaptor.

11. The pressure relief valve of claim 2, further comprising:
a bushing, coupled to said relief outlet region and configured to disengage from the relief valve outlet at a predetermined pressure allowing the relief valve to function as intended.

12. A relief valve comprising:
a housing, the housing comprising:
a threaded supply line inlet, for threadably mating with a threaded fluid outlet of a heating appliance, wherein at least said threads of said threaded supply line inlet and said threads of said threaded heating appliance fluid outlet are threaded with a reverse, left hand thread, said threaded supply line inlet for allowing fluid to enter the housing;
a relief outlet, in fluid communication with said housing and having an inlet region and an outlet region;
a valve mechanism, disposed in said housing between said supply line inlet and said inlet region of said valve mechanism, and including a valve seat in fluid communication with said housing, and configured for operation between a first, closed position closing said inlet region of said relief outlet inlet region thereby preventing fluid from exiting said relief outlet, and a second, open position opening said inlet region of said relief outlet inlet region, thereby allowing fluid to exit from said housing through said relief outlet;
a fluid supply outlet, in fluid communication with said housing, and configured for allowing fluid to exit said housing when said valve seat is in said closed position and for causing a fluid flow exiting said housing to flow proximate and against said valve seat, for flushing said valve seat; and
a bushing, coupled to said relief outlet region and configured to disengage from the relief valve outlet at a predetermined pressure allowing the relief valve to function as intended.

13. The relief valve of claim 12, wherein said outlet region of the relief outlet opens to the atmosphere.

14. The relief valve of claim 12, wherein said valve mechanism is a temperature relief valve mechanism, and wherein said temperature relief valve mechanism is operative to move from said first position to said second position upon detecting a predetermined temperature in said fluid in said housing.

15. The relief valve of claim 12, wherein said valve mechanism is a temperature relief valve mechanism, and wherein said temperature relief valve mechanism is operative to move from said first position to said second position upon detecting a predetermined temperature in a fluid holding tank into which said relief valve is inserted.

16. The pressure relief valve of claim 12 wherein the supply line inlet is connected to a water heater tank for supplying hot water from a tank to the housing.

17. The pressure relief valve of claim 12 wherein the supply line inlet further comprises an externally threaded region for engaging with an internally threaded region of a source of fluid.

18. The pressure relief valve of claim 12 wherein the supply line outlet further comprises an internally threaded region for engaging with an externally threaded region of an adaptor.

19. The pressure relief valve of claim 12 further comprising a thermal sensing element disposed along the supply line inlet and extending beyond the supply line inlet into the atmosphere.

20. The pressure relief valve of claim 12 wherein the pressure relief outlet section further comprises an internally threaded region for engaging with an externally threaded region of an adaptor.
